(19) United States
(12) Patent Application Publication
(10) Pub. No.: US 2026/0276856 A1
(43) Pub. Date: Sep. 17, 2026

(54) METHOD FOR DETERMINING PROPERTIES OF UNDERGROUND KARST CAVE

(71) Applicant: Institute of Geology and Geophysics, Chinese Academy of Sciences, Beijing (CN)

(72) Inventors: Nannan ZHOU, Beijing (CN); Guoqiang Xue, Beijing (CN); Xinhao Wei, Beijing (CN); Zhenghu Zhang, Beijing (CN); Xiaoyin Ma, Beijing (CN)

(21) Appl. No.: 19/335,321

(22) Filed: Sep. 22, 2025

Related U.S. Application Data
(63) Continuation of application No. PCT/CN2025/093283, filed on May 8, 2025.

(30) Foreign Application Priority Data
Mar. 17, 2025 (CN) 202510311682.6

(51) Int. Cl. G01V 3/38; G01V 3/08; G01V 3/36

(52) U.S. Cl. CPC G01V 3/38; G01V 3/081; G01V 3/36; G01V 2210/324; G01V 2210/665

(57) ABSTRACT

A method for determining properties of an underground karst cave is provided, including: obtaining horizontal electric field and vertical magnetic field signals of the karst cave, inputting the horizontal electric field and vertical magnetic field signals into a forward model, and obtaining resistivity and polarizability results. The forward model is obtained by training an initial forward model using a training set. Training the initial forward model using the training set includes: inputting the time-domain features into the forward model to obtain predicted data, setting priori constraint conditions, converting the constraint conditions into a multi-dataset inversion objective function, performing Taylor expansion on the multi-dataset inversion objective function while neglecting higher-order terms, obtaining first-order and second-order partial derivatives of a Taylor-expanded multi-dataset inversion objective function to derive a data update model, and iteratively correcting the initial forward model using the time-domain features and the predicted data based on the data update model.

### CROSS-REFERENCE TO RELATED APPLICATIONS

This application is a continuation of International Patent Application No. PCT/CN2025/093283, filed on May 8, 2025, and claims priority of Chinese Patent Application No. 202510311682.6, filed on Mar. 17, 2025. The contents of International Patent Application No. PCT/CN2025/093283 and Chinese Patent Application No. 202510311682.6 are hereby incorporated by reference.

### TECHNICAL FIELD

The present disclosure relates to the technical field of engineering geology, and in particular to a method for determining properties of an underground karst cave.

### BACKGROUND

Karst caves are widely distributed, with complex and diverse landforms and fragile ecosystems. During engineering construction, accidents such as foundation sliding, surface subsidence, and tunnel water inrush may occur due to cave development, leading to structural damage, as well as disruptions to the operation and construction of roads and tunnels. The formation of karst caves results from long-term dissolution by groundwater in limestone areas. The distribution of these caves is characterized by complexity, uncertainty, and concealment. Therefore, conducting detailed detection of underground karst caves and accurately determining their properties and spatial distribution patterns are crucial measures to ensure safety in areas where karst caves develop.

Based on water content, karst caves may be classified into dry caves and water-filled caves. Water-filled caves refer to karst caves with perennial groundwater flow. Dry caves are fossil caves that have become disconnected from the free water surface, developing in areas with high elevations over extended periods. These caves are often adorned with various colorful and spectacular stalactites. Currently, most karst caves exhibit features of both dry and water-filled types. Limestone is the primary surrounding rock type in karst areas and has relatively high resistivity. If a cave is water-filled, its resistivity may be very low. However, if the cave is dry, its resistivity may be very high, far exceeding that of the surrounding limestone. Therefore, achieving detailed monitoring of karst caves requires strong resolution capabilities for both high-resistivity dry caves and low-resistivity water-filled caves.

Electrical methods commonly used for shallow karst detection include electrical resistivity tomography (a geophysical method that images subsurface structures based on resistivity differences), ground penetrating radar and loop-source transient electromagnetic methods. However, whether using ground penetrating radar or electrical resistivity tomography, the detection depth is limited, generally to less than several tens of meters. These methods are often effective only for single low-resistivity or high-resistivity targets and may not simultaneously achieve detailed resolution of both low-resistivity and high-resistivity targets. The loop-source transient electromagnetic method, based on the principle of electromagnetic induction, has significantly poor resolution for high-resistivity targets and may not accurately locate high-resistivity dry caves.

### SUMMARY

To address the issues in the prior art mentioned above, the objective of the present disclosure is to provide a method for determining properties of underground karst caves. By conducting multi-component forward modeling of an electric source for both dry and water-filled caves, it is observed that water-filled caves with induced polarization effects and dry caves cause sign reversal phenomena in the horizontal electric field response, while dry caves do not cause distortion in the vertical magnetic field response. The difference in the occurrence of sign reversal phenomena in the horizontal electric field and vertical magnetic field may serve as a basis for determining the properties of underground karst caves. When only the horizontal electric field exhibits sign reversal, the underground cavity is an empty cave. When both the horizontal electric field and vertical magnetic field exhibit sign reversal phenomena simultaneously, the underground cave is a water-filled cave. Based on the validation of measured data from Tonghua karst caves through the above theoretical modeling, this method provides a new technical scheme for studying the properties of underground karst caves, particularly for detecting deeply buried caves and distinguishing their properties.

To achieve the above objective, the present disclosure provides the following scheme.

A method for determining properties of an underground karst cave includes:
obtaining horizontal electric field and vertical magnetic field signals of the karst cave, inputting the horizontal electric field and vertical magnetic field signals into a forward model, and obtaining resistivity and polarizability results, where the forward model is obtained by training an initial forward model using a training set, and the training set includes time-domain features; and
where training the initial forward model using the training set includes: inputting the time-domain features into the forward model to obtain predicted data, setting priori constraint conditions, converting the constraint conditions into a multi-dataset inversion objective function, performing Taylor expansion on the multi-dataset inversion objective function while neglecting higher-order terms, obtaining first-order and second-order partial derivatives of a Taylor-expanded multi-dataset inversion objective function to derive a data update model, and iteratively correcting the initial forward model using the time-domain features and the predicted data based on the data update model.

Optionally, obtaining the horizontal electric field and vertical magnetic field signals of the karst cave includes:
obtaining a depth of the karst cave, determining a grounded wire source and an offset based on the depth of the karst cave, which is used to arrange multi-point observation devices around the karst cave; and
performing forward modeling based on the multi-point observation devices, calculating anomalous responses caused by karst caves of different sizes, burial depths, and shapes, establishing a curve set, inferring a collection time range from time causing the anomalous responses, and obtaining horizontal electric field and vertical magnetic field signals at different time periods using time-based sampling.

Optionally, obtaining the time-domain features includes:
removing background noise from the original horizontal electric field and vertical magnetic field signals and enhancing signal strength; where the background noise includes environmental noise and interference generated by equipment; and
normalizing enhanced signals, performing data segmentation to obtain signal features at the different time periods, and extracting the time-domain features using gradient changes.

Optionally, after extracting the time-domain features, the method further includes:
comparing and analyzing the time-domain features with the curve set; where if a data curve exhibits negative values, a determination is made as to whether the values result from irregular variations caused by noise or regular variations attributable to the underground karst cave; and if the time-domain features show regular variation, the time-domain features are used to identify potential karst cave properties.

Optionally, setting the priori constraint conditions includes:

$${P}^{α} ( m ) = φ ( m ) + as ( m ) ,$$

where P^{a}(m) is a total objective function, a is a regularization factor, φ(m) is a sum of squared differences between observed data and the predicted data, and s (m) is a stabilizer.

Optionally, an expression of the multi-dataset inversion objective function is:

$${P}^{α} ( m ) = {‖ {W}_{1} [ {d}^{obs 1} - {F}_{1} ( m ) ] ‖}^{2} + {‖ {W}_{2} [ {d}^{obs 2} - {F}_{2} ( m ) ] ‖}^{2} + … + {‖ {W}_{n} [ {d}^{obsn} - {F}_{n} ( m ) ] ‖}^{2} + α {‖ m - {m}^{ref} ‖}^{2} ,$$

where d^{obsn} is measured data from different field quantities or observation areas, Fₙ (m) is a response function, m^{ref} is a prior model, W₁ and W₂ are weight coefficient matrices for the measured data at 1st and 2nd iterations respectively, and m is a model corresponding to the measured data.

Optionally, obtaining the data update model includes:

$${m}^{k + 1} = {m}^{k} + Δ m = {m}^{k} + \{ \begin{matrix}{J}_{1}^{T} {W}_{1}^{T} {W}_{1} [ {d}^{obs 1} - {F}_{1} ( m ) ] + \\ {J}_{2}^{T} {W}_{2}^{T} {W}_{2} [ {d}^{obs 2} - {F}_{2} ( m ) ] + … + \\ {J}_{e}^{T} {W}_{n}^{T} {W}_{n} [ {d}^{obsn} - {F}_{n} ( m ) ] + \\ α ( {m}^{ref} - m )\end{matrix} \} {( {J}_{1}^{T} {W}_{1}^{T} {W}_{1} {J}_{1} + {J}_{2}^{T} {W}_{2}^{T} {W}_{2} {J}_{2} + … + {J}_{n}^{T} {W}_{n}^{T} {W}_{n} {J}_{n} + α )}^{- 1} ,$$

where J is a sensitivity matrix, m^{k} is an iterative model, n is the number of the iterations, Wₙ is a weight coefficient matrix for the measured data at an n-th iteration, and T is a transpose operation.

Optionally, the method further includes: presenting the resistivity and polarizability results in a form of charts or reports to display the determined karst cave properties and associated geological features.

The beneficial effects of the present disclosure are as follows.

The present disclosure, according to the data update model, iteratively corrects the initial forward model using the time-domain features and predicted data. By using a model that meets accuracy requirements to simulate actual geological conditions, the disclosure achieves fine detection of large-depth karst caves and detailed distinction of karst cave properties. The disclosure also ensures the effectiveness of determining karst cave properties and the efficiency of specific implementation.

### BRIEF DESCRIPTION OF THE DRAWINGS

To more clearly illustrate the technical schemes in the embodiments of the present disclosure or the prior art, the following will briefly describe the drawings required for the embodiments. Obviously, the drawings in the following description are only some embodiments of the present disclosure. For those of ordinary skill in the art, other drawings may be obtained based on these drawings without creative effort.

FIG. 1 is a flowchart of a method for determining properties of an underground karst cave according to an embodiment of the present disclosure.

FIG. 2A is a response curve of horizontal electric field caused by the dry cave in the embodiment of the present disclosure.

FIG. 2B is a response curve of vertical magnetic field caused by the dry cave in the embodiment of the present disclosure.

FIG. 3A is a response curve of horizontal electric field caused by the water-filled cave in the embodiment of the present disclosure.

FIG. 3B is a response curve of vertical magnetic field caused by the water-filled cave in the embodiment of the present disclosure.

FIG. 4 is a survey line layout diagram according to an embodiment of the present disclosure.

FIG. 5A is a typical response curve of the survey line L18 at the survey point 10 meters (m) according to the embodiment of the present disclosure.

FIG. 5B is a typical response curve of the survey line L18 at the survey point 200 m according to the embodiment of the present disclosure.

FIG. 6A is a typical response curve of the survey line L12 at the survey point 20 m according to the embodiment of the present disclosure.

FIG. 6B is a typical response curve of the survey line L12 at the survey point 70 m according to the embodiment of the present disclosure.

FIG. 6C is a typical response curve of the survey line L12 at the survey point 250 m according to the embodiment of the present disclosure.

### DETAILED DESCRIPTION OF THE EMBODIMENTS

The following will clearly and completely describe the technical schemes in the embodiments of the present disclosure with reference to the accompanying drawings. Obviously, the described embodiments are only a part of the embodiments of the present disclosure, and not all of them. All other embodiments obtained by a person of ordinary skill in the art based on the embodiments of the present disclosure without creative efforts shall fall within the protection scope of the present disclosure.

To make the above objectives, features, and advantages of the present disclosure more clearly understood, the following provides a further detailed description of the present disclosure in conjunction with the accompanying drawings and specific implementation methods.

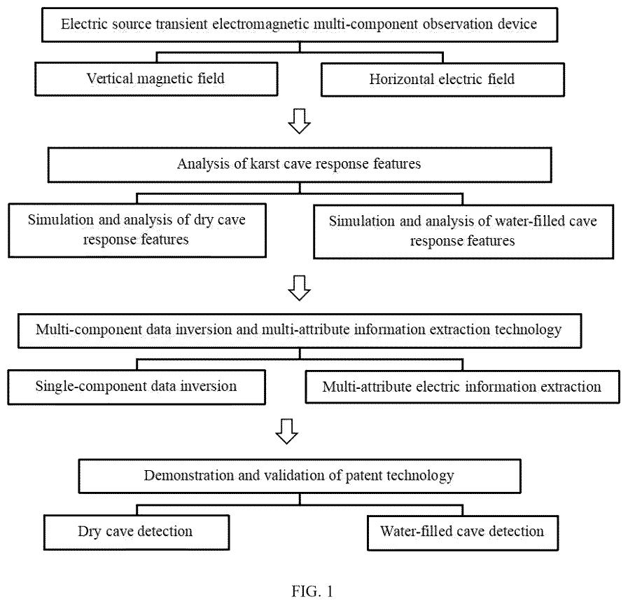

As shown in FIG. 1, this embodiment discloses a method for determining properties of an underground karst cave, including: obtaining horizontal electric field and vertical magnetic field signals of the karst cave, inputting the horizontal electric field and vertical magnetic field signals into a forward model, and obtaining resistivity and polarizability results, where the forward model is obtained by training an initial forward model using a training set, and the training set includes time-domain features; where training the initial forward model using the training set includes: inputting the time-domain features into the forward model to obtain predicted data, setting priori constraint conditions, converting the constraint conditions into a multi-dataset inversion objective function, performing Taylor expansion on the multi-dataset inversion objective function while neglecting higher-order terms, obtaining first-order and second-order partial derivatives of a Taylor-expanded multi-dataset inversion objective function to derive a data update model, and iteratively correcting the initial forward model using the time-domain features and the predicted data based on the data update model.

In this embodiment, obtaining the horizontal electric field and vertical magnetic field signals of the karst cave includes: obtaining a depth of the karst cave, determining a grounded wire source and an offset based on the depth of the karst cave, which is used to arrange multi-point observation devices around the karst cave; and performing forward modeling based on the multi-point observation devices, calculating anomalous responses caused by karst caves of different sizes, burial depths, and shapes, establishing a curve set, inferring a collection time range from time causing the anomalous responses, and obtaining horizontal electric field and vertical magnetic field signals at different time periods using time-based sampling.

Specifically, the horizontal electric field and vertical magnetic field signals of the karst cave are collected.

In this step, accurately collecting electromagnetic signals of the underground karst cave is the basis for determining its properties. The following is a detailed description of the collection process.

### 1. Equipment Arrangement

Grounded wire source: based on the preliminary geological survey results, the approximate depth of the detection target is analyzed, and an appropriate grounded wire source and offset are selected to ensure wide coverage within the target area.

Transient electromagnetic multi-component observation device: multi-point observation devices are arranged around the karst cave simultaneously to capture equatorial electric and magnetic field signals. The horizontal electric field may be strictly parallel to the transmission source, and the receiving electrode spacing may be strictly arranged with the design to receive electrodes. Magnetic field collection uses a magnetic probe, which may be completely perpendicular to the ground surface.

### 2. Signal Collection

Curve set acquisition through forward modeling: the responses caused by karst caves of different sizes, burial depths, and shapes are calculated, and a curve set is established.

Time range selection: based on the depth and geological environment of the target karst cave, forward modeling is conducted to infer the collection time range from the time of the anomalous response. Generally, signals with low fundamental frequencies are more suitable for deep-layer detection, while signals with high fundamental frequencies may provide higher resolution.

Data collection strategy: time-based sampling is used to ensure sufficient signal data is collected during different time periods for comprehensive analysis.

### 3. Signal Processing

Noise filtering: after signal collection, digital filtering techniques are used to remove background noise, including environmental noise and interference generated by the equipment itself.

Signal enhancement: the strength and clarity of useful signals are improved through signal enhancement algorithms for subsequent analysis.

### 4. Data Recording and Storage

Real-time monitoring: during the signal collection process, the quality and completeness of the data are monitored in real time to ensure important data is not lost.

Data storage: the collected electric and magnetic field signals are saved to a data storage system using appropriate formats and structures for subsequent analysis and processing.

In this embodiment, obtaining the time-domain features includes: removing background noise from the original horizontal electric field and vertical magnetic field signals and enhancing signal strength; where the background noise includes environmental noise and interference generated by equipment; and normalizing enhanced signals, performing data segmentation to obtain signal features at the different time periods, and extracting the time-domain features using gradient changes.

In this embodiment, after extracting the time-domain features, the method further includes: comparing and analyzing the time-domain features with the curve set; where if a data curve exhibits negative values, a determination is made as to whether the values result from irregular variations caused by noise or regular variations attributable to the underground karst cave; and if the time-domain features show regular variation, the time-domain features are used to identify potential karst cave properties.

Specifically, processing the horizontal electric field and vertical magnetic field signals includes: after completing signal collection, the next step is to conduct in-depth analysis of the horizontal electric field and vertical magnetic field signals to determine the properties of the underground karst cave. The following is a detailed description of this step.

### 1. Data Preprocessing

Signal normalization: the collected electric and magnetic field signals are normalized to eliminate the effects of signal strength variations at different locations and ensure comparability of the analysis results.

Data segmentation: the continuous signal data is segmented to facilitate comparison and analysis of signal features across different time periods.

### 2. Feature Extraction

Time-domain feature extraction: when no geological bodies such as karst caves are present, the observed response signal is monotonic, and thus the gradient of the observed data is positive values. However, when influenced by target bodies such as karst caves, the calculated response gradient exhibits negative values. Gradient changes are utilized to extract time-domain features of the signal, such as the maximum value, minimum value, mean value, variance, with particular attention being paid to sign reversal features. These features are compared and analyzed with the curve set from prior forward modeling. When negative values are shown in the data curve, the error bars of the data are analyzed to determine the nature of the negative values-whether they are irregular variations caused by noise or regular variations caused by an underground karst cave. When regular variations are exhibited in the data, they may be used to identify potential karst cave properties.

### 3. Determination of Karst Cave Properties

Joint data inversion: the resistivity and polarizability features of the underground geological body are inverted and obtained, and information such as the burial depth and spatial distribution of the karst cave is obtained.

In this embodiment, setting the priori constraint conditions includes:

$${P}^{α} ( m ) = φ ( m ) + as ( m ) ,$$

where P^{a}(m) is a total objective function, a is a regularization factor, φ(m) is a sum of squared differences between observed data and the predicted data, and s(m) is a stabilizer.

In this embodiment, the expression of the multi-dataset inversion objective function is:

$${P}^{α} ( m ) = {‖ {W}_{1} [ {d}^{obs 1} - {F}_{1} ( m ) ] ‖}^{2} + {‖ {W}_{2} [ {d}^{obs 2} - {F}_{2} ( m ) ] ‖}^{2} + … + {‖ {W}_{n} [ {d}^{obsn} - {F}_{n} ( m ) ] ‖}^{2} + α {‖ m - {m}^{ref} ‖}^{2} ,$$

where d^{obsn} is measured data from different field quantities or observation areas, Fₙ (m) is a response function, Wₙ is a weight coefficient matrix for the measured data, m^{ref} is a prior model, α is a regularization factor, W₁ and W₂ are weight coefficient matrices for the measured data at 1st and 2nd iterations respectively, and m is a model corresponding to the measured data.

In this embodiment, during the process of obtaining the first-order and second-order partial derivatives of the Taylor-expanded multi-dataset inversion objective function, differentiation is performed with respect to Δm in the Taylor-expanded multi-dataset inversion objective function:

$$Δ m = - \frac{\partial {P}^{α} ( {m}^{k} )}{\partial m} \cdot {[ \frac{{\partial }^{2} {P}^{α} ( {m}^{k} )}{\partial {m}^{2}} ]}^{- 1} ,$$

where Δm is the model parameter residual, and P^{α}(m^{k}) is the objective function.

In this embodiment, obtaining the data update model includes:

$${m}^{k + 1} = {m}^{k} + Δ m = {m}^{k} + \{ \begin{matrix}{J}_{1}^{T} {W}_{1}^{T} {W}_{1} [ {d}^{obs 1} - {F}_{1} ( m ) ] + \\ {J}_{2}^{T} {W}_{2}^{T} {W}_{2} [ {d}^{obs 2} - {F}_{2} ( m ) ] + … + \\ {J}_{e}^{T} {W}_{n}^{T} {W}_{n} [ {d}^{obsn} - {F}_{n} ( m ) ] + \\ α ( {m}^{ref} - m )\end{matrix} \} {( {J}_{1}^{T} {W}_{1}^{T} {W}_{1} {J}_{1} + {J}_{2}^{T} {W}_{2}^{T} {W}_{2} {J}_{2} + … + {J}_{n}^{T} {W}_{n}^{T} {W}_{n} {J}_{n} + α )}^{- 1} ,$$

where J is a sensitivity matrix, m^{k} is an iterative model, n is the number of the iterations, Wₙ is a weight coefficient matrix for the measured data at an n-th iteration, α is a regularization factor, and T is a transpose operation.

In this embodiment, the method also includes: presenting the resistivity and polarizability results in a form of charts or reports to display the determined karst cave properties and associated geological features.

Specifically, for inversion problems, the non-uniqueness of the solution arises from the limited nature of the observed data and the presence of errors in the observed data. Extending the inversion of a single dataset to the simultaneous inversion of multiple datasets and obtaining a geophysical model that satisfies multiple datasets improves the reliability of the results. In principle, these datasets may be of any type and may be used to interpret the same model.

A comprehensive study of the joint inversion of a pair of grounded wire source transient electromagnetic multi-component data is carried out. To improve stability and address non-uniqueness issues, a regularized inversion method is introduced, which enhances the stability of the inversion process and reduces the non-uniqueness of the inversion results by incorporating priori constraint conditions.

$${P}^{α} ( m ) = φ ( m ) + as ( m ) .$$

In the formula, P^{a}(m) is the total objective function; a is the regularization factor; φ(m) is the sum of squared differences between the observed data and the predicted data (data objective function); and s (m) is the stabilizer (model constraint objective function).

The multi-dataset inversion objective function may be expressed as:

$${P}^{α} ( m ) = {‖ {W}_{1} [ {d}^{obs 1} - {F}_{1} ( m ) ] ‖}^{2} + {‖ {W}_{2} [ {d}^{obs 2} - {F}_{2} ( m ) ] ‖}^{2} + … + {‖ {W}_{n} [ {d}^{obsn} - {F}_{n} ( m ) ] ‖}^{2} + α {‖ m - {m}^{ref} ‖}^{2} .$$

In the formula, d^{obsn} is measured data from different field quantities or observation areas, Fₙ (m) is a response function, Wₙ is a weight coefficient matrix for the measured data, and m^{ref} is a prior model.

Taylor expansion is performed on the objective function and higher-order terms are neglected to achieve linearization of the nonlinear objective function:

$${P}^{α} ( {m}^{k} + Δ m ) = {P}^{α} ( m ) + \frac{\partial {P}^{α} ( m )}{\partial m} Δ m + \frac{1}{2} Δ {m}^{k} \frac{{\partial }^{2} {P}^{α} ( m )}{{\partial }^{2} m} Δ {m}^{2} + O ‖ {( Δ m )}^{2} ‖ .$$

In the formula, m^{k} is the k-th iterative value of the model.

The inversion iterative update formula is obtained by differentiating with respect to Δm:

$$Δ m = - \frac{\partial {P}^{α} ( {m}^{k} )}{\partial m} \cdot {[ \frac{{\partial }^{2} {P}^{α} ( {m}^{k} )}{\partial {m}^{2}} ]}^{- 1} .$$

The first-order and second-order partial derivatives of the objective function are taken to finally obtain the data update formula:

$${m}^{k + 1} = {m}^{k} + Δ m = {m}^{k} + \{ \begin{matrix}{J}_{1}^{T} {W}_{1}^{T} {W}_{1} [ {d}^{obs 1} - {F}_{1} ( m ) ] + \\ {J}_{2}^{T} {W}_{2}^{T} {W}_{2} [ {d}^{obs 2} - {F}_{2} ( m ) ] + … + \\ {J}_{e}^{T} {W}_{n}^{T} {W}_{n} [ {d}^{obsn} - {F}_{n} ( m ) ] + \\ α ( {m}^{ref} - m )\end{matrix} \} {( {J}_{1}^{T} {W}_{1}^{T} {W}_{1} {J}_{1} + {J}_{2}^{T} {W}_{2}^{T} {W}_{2} {J}_{2} + … + {J}_{n}^{T} {W}_{n}^{T} {W}_{n} {J}_{n} + α )}^{- 1} .$$

In the formula, J is the sensitivity matrix. The forward model m is iteratively corrected using the data update formula m^{k+1}. Finally, a model meeting the accuracy requirements (the model accuracy may be determined by the sum of squared differences or residuals between the observed data and the predicted data) is used to simulate the actual geological conditions.

Joint inversion of multiple datasets may overall improve the reliability of the results. The provided multiple datasets contain complementary information, and the resistivity and polarizability results are obtained.

Uncertainty analysis: the uncertainty of the determination results is evaluated and potential sources of error are analyzed. The reliability of the determination is enhanced through multiple tests and cross-validation.

Result visualization: the analysis results are presented in the form of charts or reports, with the determined karst cave properties and their possible geological features being clearly displayed.

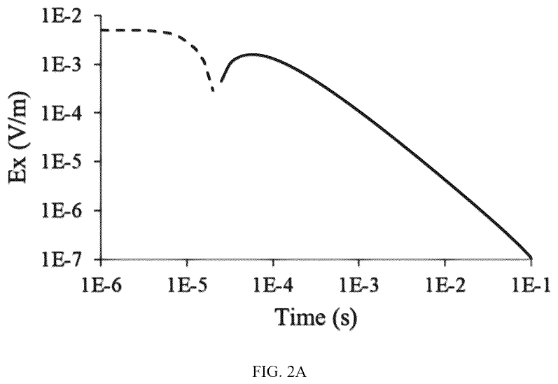

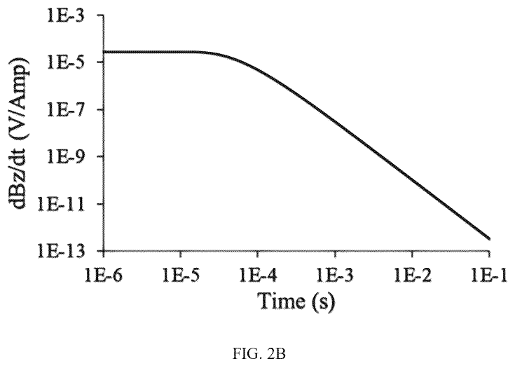

This embodiment also conducts forward modeling of the horizontal electric field and vertical magnetic field responses of an electric source transient electromagnetic method for karst caves of different properties. Through response features and root mean square (RMS) analysis, it is found that the horizontal electric field is sensitive to both low-resistivity, high-polarization water-filled caves and high-resistivity dry caves, while the vertical magnetic field is only sensitive to low-resistivity, high-polarization water-filled caves, as shown in FIG. 2A and FIG. 2B. Low-resistivity, high-polarization water-filled caves and high-resistivity dry caves cause distortion and even sign reversal in the vertical magnetic field and horizontal electric field responses, while dry caves only cause sign reversal in the horizontal electric field response. This difference may be used as a basis for judging the water content of underground karst caves.

For high-resistivity dry caves, the presence of a high-resistivity layer causes sign reversal in the horizontal electric field. This is due to charge accumulation at the low-to-high resistivity interface, leading to distortion and sign reversal of the electric field response. In contrast, the vertical magnetic field does not exhibit significant distortion or sign reversal. Both low-resistivity, high-polarization water-filled caves and high-resistivity dry caves cause sign reversal in the horizontal electric field, while sign reversal in the vertical magnetic field is only caused by low-resistivity, high-polarization water-filled caves.

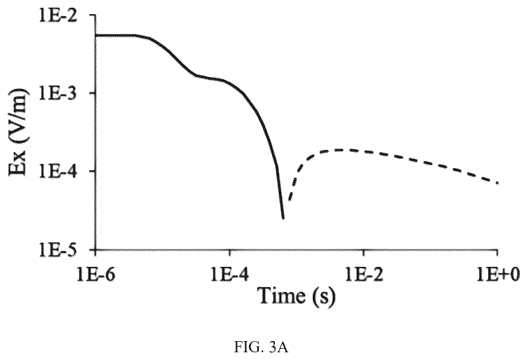

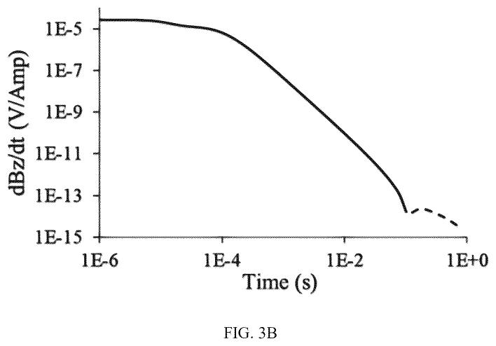

When a low-resistivity, polarizable water-filled cave exists, both the time derivatives of the horizontal electric field and vertical magnetic field exhibit sign reversal phenomena. Compared to the vertical magnetic field component, the sign reversal in the horizontal electric field occurs before one multiplied by ten to the power of negative three seconds (1e-3 s) (FIG. 3A), while the sign reversal in the vertical magnetic field occurs around one multiplied by ten to the power of negative one seconds (1e-1 s) (FIG. 3B). The low-resistivity polarizable layer has a greater impact on the horizontal electric field.

The study area is located on the northeastern margin of the North China Craton. The stratigraphic development in the region is relatively complete, mainly including the Archean, Proterozoic, Paleozoic, Mesozoic, and Cenozoic. The Archean rock groups include the Anshan Group, the Proterozoic includes the Ji'an Group, the Laoling Group, and the Sinian System. The Paleozoic includes the Cambrian, Ordovician, Carboniferous, and Permian. The Mesozoic includes the Triassic, Jurassic, and Cretaceous. The Cenozoic includes the Neogene and Quaternary.

In terms of geotectonics, it belongs to the North China stratigraphic region, distributing carbonate rock formations from the Middle Proterozoic to the Lower Paleozoic. Among them, the Middle Ordovician Majiagou Formation and the Sinian Badaojiang Formation have large thickness and high purity, providing a good material basis for the development of karst caves.

The Tonghua karst cave develops in the Ordovician Majiagou limestone formation, which is a shallow marine carbonate rock. Due to the large thickness, high purity, strong rigidity, conducive to the expansion of joints and fractures, and good permeability of the limestone, it may develop into long and large karst caves. The formation of karst caves is significantly influenced by geological structures. The structural morphology of the rock layers, such as folds, tilting, or horizontality, has a significant effect on cave development. In terms of geological structure, the Yunxia karst cave is located in the Hunjiang fault-fold belt, which mainly consists of the North East-trending Hunjiang synclinorium in the Paleozoic of central Tonghua area, including the North East-trending fault zones on both sides. Structurally, it belongs to a tensional fault zone, and groundwater tracks along this tensional fault zone, developing karst and forming underground river channels. The Hunjiang fault-fold belt is also fragmented by other structures, such as North North East-trending faults. Therefore, the intersections of structures are dissolved, expanded, and collapsed to form solution pits. With the occurrence of neotectonic movements, the crust uplifts, and the groundwater level drops, facilitating the continuation of groundwater dissolution and mechanical erosion. The karst process, initially dominated by horizontal dissolution, transforms into one dominated by vertical collapse and dissolution, further expanding the solution pits into cave halls.

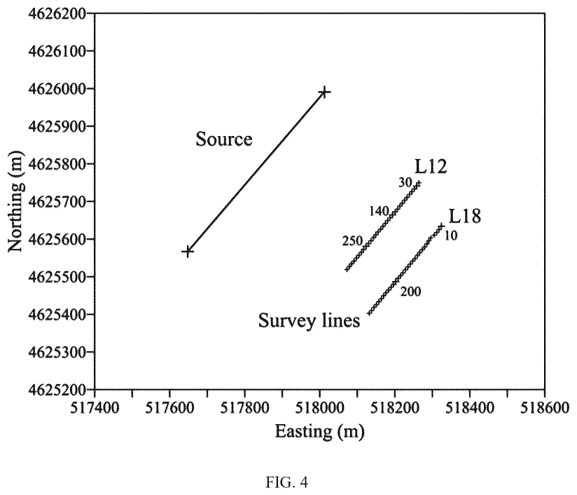

FIG. 4 shows the distribution of the transmission source and the measured survey lines. The transmission source has a length of 600 meters (m). The offsets between the two survey lines and the transmission source are 380 m and 500 m respectively.

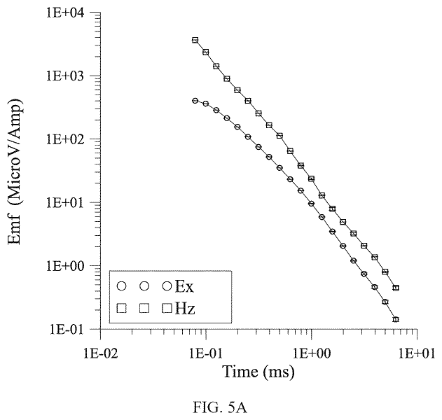

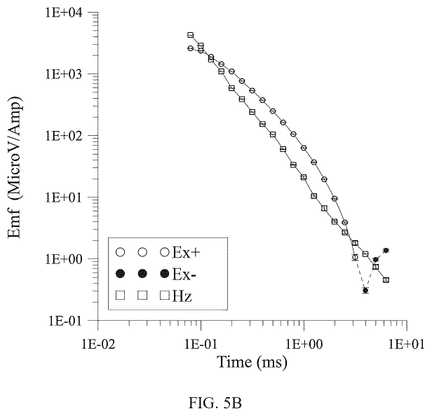

As shown in FIG. 5A and FIG. 5B, neither the horizontal electric field nor the vertical magnetic field at survey point 10 m exhibits sign reversal phenomena. However, at survey point 200 m, the horizontal electric field shows sign reversal between 1 millisecond (ms) and 10 ms, while the vertical magnetic field does not exhibit this phenomenon.

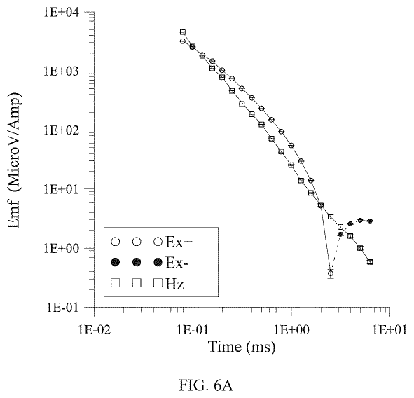

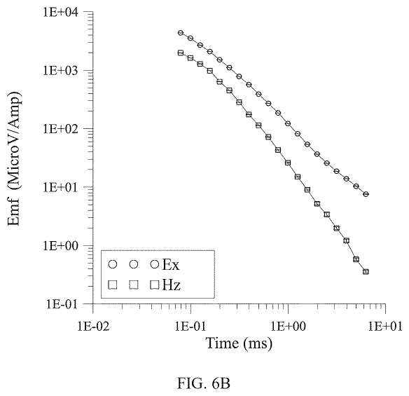

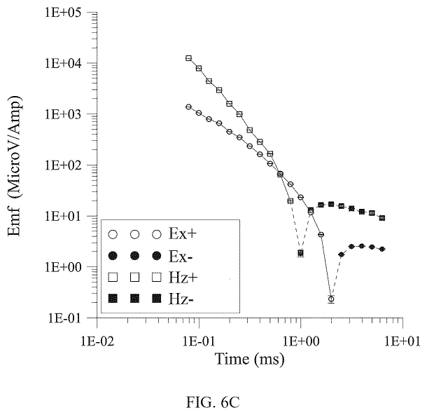

As shown in FIG. 6A, FIG. 6B and FIG. 6C, which depict the response curves of typical survey points on survey line L12, three scenarios are observed in the measured data of survey line L12: at survey point 70 m, neither the horizontal electric field nor the vertical magnetic field exhibits sign reversal; at survey point 20 m, the horizontal electric field shows sign reversal, but the vertical magnetic field does not; and at survey point 250 m, both the horizontal electric field and the vertical magnetic field exhibit sign reversal phenomena.

The embodiments described above are merely illustrative of the optional embodiments of the present disclosure and do not limit the scope of the disclosure. Without departing from the design spirit of the present disclosure, any modifications and improvements made to the technical schemes of the present disclosure by those of ordinary skill in the art shall fall within the protection scope defined by the claims of the present disclosure.

What is claimed is:

1. A method for determining properties of an underground karst cave, comprising:
obtaining horizontal electric field and vertical magnetic field signals of the karst cave, inputting the horizontal electric field and vertical magnetic field signals into a forward model, and obtaining resistivity and polarizability results, wherein the forward model is obtained by training an initial forward model using a training set, and the training set comprises time-domain features;
wherein training the initial forward model using the training set comprises: inputting the time-domain features into the forward model to obtain predicted data, setting priori constraint conditions, converting the constraint conditions into a multi-dataset inversion objective function, performing Taylor expansion on the multi-dataset inversion objective function while neglecting higher-order terms, obtaining first-order and second-order partial derivatives of a Taylor-expanded multi-dataset inversion objective function to derive a data update model, and iteratively correcting the initial forward model using the time-domain features and the predicted data based on the data update model;
wherein setting the priori constraint conditions comprises:
P^{a}(m)=φ(m)+as(m),
wherein P^{a}(m) is a total objective function, a is a regularization factor, φ(m) is a sum of squared differences between observed data and the predicted data, and s (m) is a stabilizer;
an expression of the multi-dataset inversion objective function is:
$${P}^{α} ( m ) = {‖ {W}_{1} [ {d}^{obs 1} - {F}_{1} ( m ) ] ‖}^{2} + {‖ {W}_{2} [ {d}^{obs 2} - {F}_{2} ( m ) ] ‖}^{2} + … + {‖ {W}_{n} [ {d}^{obsn} - {F}_{n} ( m ) ] ‖}^{2} + α {‖ m - {m}^{ref} ‖}^{2} ,$$
wherein d^{obsn} is measured data from different field quantities or observation areas, Fₙ(m) is a response function, m^{ref} is a prior model, W₁ and W₂ are weight coefficient matrices for the measured data at 1st and 2nd iterations respectively, and m is a model corresponding to the measured data; and
obtaining the data update model comprises:
$${m}^{k + 1} = {m}^{k} + Δ m = {m}^{k} + \{ \begin{matrix}{J}_{1}^{T} {W}_{1}^{T} {W}_{1} [ {d}^{obs 1} - {F}_{1} ( m ) ] + \\ {J}_{2}^{T} {W}_{2}^{T} {W}_{2} [ {d}^{obs 2} - {F}_{2} ( m ) ] + … + \\ {J}_{e}^{T} {W}_{n}^{T} {W}_{n} [ {d}^{obsn} - {F}_{n} ( m ) ] + \\ α ( {m}^{ref} - m )\end{matrix} \} {( {J}_{1}^{T} {W}_{1}^{T} {W}_{1} {J}_{1} + {J}_{2}^{T} {W}_{2}^{T} {W}_{2} {J}_{2} + … + {J}_{n}^{T} {W}_{n}^{T} {W}_{n} {J}_{n} + α )}^{- 1} ,$$
wherein J is a sensitivity matrix, m^{k} is an iterative model, n is number of the iterations, Wₙ is a weight coefficient matrix for the measured data at an n-th iteration, and T is a transpose operation.

2. The method for determining the properties of the underground karst cave according to claim 1, wherein obtaining the horizontal electric field and vertical magnetic field signals of the underground karst cave comprises:
obtaining a depth of the underground karst cave, determining a grounded wire source and an offset based on the depth of the underground karst cave, so as to arrange multi-point observation devices around the underground karst cave; and
performing forward modeling based on the multi-point observation devices, calculating anomalous responses caused by karst caves of different sizes, burial depths, and shapes, establishing a curve set, inferring a collection time range from time causing the anomalous responses, and obtaining the horizontal electric field and vertical magnetic field signals at different time periods using time-based sampling.

3. The method for determining the properties of the underground karst cave according to claim 1, wherein obtaining the time-domain features comprises:
removing background noise from original horizontal electric field and vertical magnetic field signals and enhancing signal strength; wherein the background noise comprises environmental noise and interference generated by equipment; and
normalizing enhanced signals, performing data segmentation to obtain signal features at different time periods, and extracting the time-domain features using gradient changes.

4. The method for determining the properties of the underground karst cave according to claim 2, wherein after extracting the time-domain features, the method further comprises:
comparing and analyzing the time-domain features with the curve set; wherein when a data curve exhibits negative values, a determination is made as to whether the values result from irregular variations caused by noise or regular variations attributable to the underground karst cave; and when the time-domain features show regular variation, the time-domain features are used to identify potential karst cave properties.

5. The method for determining the properties of the underground karst cave according to claim 1, further comprising: presenting the resistivity and polarizability results in a form of charts or reports to display the properties of the underground karst cave and associated geological features.
